(19) United States
(12) Patent Application Publication
(10) Pub. No.: US 2010/0214328 A1
(43) Pub. Date: Aug. 26, 2010

(54) IMAGE DISPLAY DEVICE, ELECTRONIC APPARATUS, AND IMAGE DISPLAY METHOD

(75) Inventor: Hiroyuki HARA, Chino-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/706,322

(22) Filed: Feb. 16, 2010

(30) Foreign Application Priority Data
Feb. 26, 2009 (JP) 2009-043567

(51) Int. Cl. G09G 5/10

(52) U.S. Cl. 345/690

(57) ABSTRACT

An image display device includes a motion detector that detects a magnitude of motion between frames from image data containing an image to be displayed, a frame number adjuster that adjusts the number of frames per unit time based on a detection result from the motion detector, a sub-frame number adjuster that adjusts the number of sub-frames included in one frame based on the detection result, and a controller that controls the frame number adjuster and the sub-frame number adjuster such that: when the detected magnitude is large, the number of frames is made larger and the number of sub-frames is made smaller in comparison with the case where the detected magnitude is small; and when the detected magnitude is small, the number of frames is made smaller and the number of sub-frames is made larger in comparison with the case where the detected magnitude is large.

### BACKGROUND

1. Technical Field

The present invention relates to a technique of displaying an image by subfield driving.

2. Related Art

For example, JP-A-2008-193487 discloses a technique of improving deterioration of image quality due to motion blur as follows. That is, intermediate frame images are interpolated between a (N−1)^{th} frame image and an N^{th} frame image and a frame rate is doubled so that deterioration of image quality due to motion blur is improved. Further, JP-A-2003-114661 discloses a technique of controlling a gradation of a display image by displaying an image by subfield driving. In other words, in JP-A-2003-114661, one field is divided into a plurality of subfields and a turn-on voltage or a turn-off voltage is applied to each pixel on a subfield basis so that a gradation of a display image is controlled.

When techniques disclosed in JP-A-2008-193487 and JP-A-2003-114661 are combined, a cycle of sub-frame is halved if the frame rate is doubled. In this case, each pixel is required to be driven at a doubled operation speed. In addition, when an image is displayed by the subfield driving, a turn-on voltage or a turn-off voltage is required to be written into each of all pixels constituting one screen not on a frame basis but on a subfield basis. Therefore, a writing time (selection time) of the voltage into each pixel becomes significantly short.

In the case of a moving image, it is often important for improving image quality that the number of frames per unit time is increased so as to interpolate intermediate frame image(s) rather than that the number of sub-frames per frame is increased so as to improve definition of a gradation display. On the other hand, in the case of a still image, a display image does not change unlike the moving image. Therefore, it is often important for improving image quality that the number of sub-frames per frame is increased so as to improve definition of a gradation display rather than that the number of frames per unit time is increased.

### SUMMARY

An advantage of some aspects of the invention is to provide an image display device, an electronic apparatus and an image display method, which can suitably improve image quality regardless of an image to be displayed being a moving image or a still image, when the image is displayed by the subfield driving.

An image display device according to an aspect of the invention controls each gradation of a plurality of pixels in each of a plurality of sub-frames obtained by dividing one frame when a unit period to display one screen made of the plurality of pixels is set to be one frame. The image display device includes a motion detector that detects a magnitude of motion between frames from image data containing an image to be displayed, a frame number adjuster that adjusts the number of frames per unit time based on a detection result from the motion detector, a sub-frame number adjuster that adjusts the number of sub-frames included in one frame based on the detection result, and a controller that controls the frame number adjuster and the sub-frame number adjuster such that: when the detected magnitude is large, the number of frames is made larger and the number of sub-frames is made smaller in comparison with the case where the detected magnitude is small; and when the detected magnitude is small, the number of frames is made smaller and the number of sub-frames is made larger in comparison with the case where the detected magnitude is large.

In this configuration, when motion between frames is large, the number of frames can be larger and the number of sub-frames can be smaller in comparison with the case where the motion between frames is small. On the other hand, when motion between frames is small, the number of frames can be smaller and the number of sub-frames can be larger in comparison with the case where the motion between frames is large. That is to say, in the case of an image of which motion between frames is large (for example, a moving image), even though definition of a gradation display is degraded by reducing the number of sub-frames per frame, the number of frames per unit time is increased to interpolate intermediate frame image(s) instead so as to smoothly display the image. On the other hand, in the case of an image of which motion between frames is small (for example, a still image), a display image does not change so large. Therefore, the number of frames per unit time is reduced, and the number of sub-frames per frame is increased instead, thereby realizing a gradation display at higher definition. Accordingly, when an image is displayed by the subfield driving, image quality can be suitably improved, regardless of the image to be displayed being a moving image or a still image.

In the image display device described above, the image data preferably has frame image data corresponding to each frame. Further, it is preferable that when the detected magnitude is large, the frame number adjuster generate intermediate image data corresponding to an intermediate frame between one frame and a frame next to the frame to increase the number of frames in comparison with the case where the detected magnitude is small. In this case, an image such as a moving image of which motion between frames is large can be smoothly displayed by generating the intermediate image data. It is to be noted that the intermediate image data interpolated between one frame and a frame next to the frame is not limited to one and may be plural. The intermediate image data is generated by using frame image data corresponding to one frame and frame image data corresponding to a frame next to the frame.

In the image display device described above, the image data preferably has frame image data corresponding to each frame. Further, it is preferable that when the detected magnitude is small, the frame number adjuster thin out the frame image data at a constant rate every predetermined number of continuous frames to reduce the number of frames in comparison with the case where the detected magnitude is large. In this case, the number of frames per unit time can be reduced by thinning out the frame image data to increase the number of sub-frames per frame instead. For example, the frame image data can be thinned out at a rate: one of every two frames, or three of every four frames.

The image display device described above preferably includes a plurality of look-up tables indicating correspondence of a gradation to be displayed and an ON state or an OFF state in each of a plurality of sub-frames included in one frame in accordance with the number of sub-frames included in one frame. In the image display device, it is preferable that when the detected magnitude is large, the sub-frame number adjuster select a look-up table in which the number of sub-frames is small so as to control each gradation of the plurality of pixels by using the selected look-up table, thereby reducing the number of sub-frames in comparison with the case where the detected magnitude is small. Further, it is preferable that when the detected magnitude is small, the sub-frame number adjuster select a look-up table in which the number of sub-frames is large so as to control each gradation of the plurality of pixels by using the selected look-up table, thereby increasing the number of sub-frames in comparison with the case where the detected magnitude is large. In this case, the look-up table is selected in accordance with the magnitude of motion between frames so as to control a gradation of each pixel by using the selected look-up table, thereby adjusting the number of sub-frames per frame.

In the image display device described above, the motion detector preferably detects presence or absence of motion between frames from image data containing the image to be displayed. It is preferable that when the detection result indicates presence of motion, the controller control the frame number adjuster and the sub-frame number adjuster such that the number of frames is made larger and the number of sub-frames is made smaller in comparison with the case where the detection result indicates absence of motion. Further, it is preferable that when the detection result indicates absence of motion, the controller control the frame number adjuster and the sub-frame number adjuster such that the number of frames is made smaller and the number of sub-frames is made larger in comparison with the case where the detection result indicates presence of motion. That is to say, an image can be determined to be a moving image or a still image by detecting presence or absence of motion between frames. When a moving image is displayed, the number of frames per unit time is larger and the number of sub-frames per one frame is smaller in comparison with the case where a still image is displayed. In contrast, when a still image is displayed, the number of frames per unit time is smaller and the number of sub-frames per one frame is larger in comparison with the case where a moving image is displayed.

In the image display device described above, it is preferable that the controller control the frame number adjuster and the sub-frame number adjuster such that a result of multiplication of the number of frames by the number of sub-frames is constant. Further, in the image display device described above, it is preferable that the sub-frame number adjuster adjust the number of sub-frames such that the unit period of the sub-frames is constant even when the number of frames is changed. In the above configurations, the unit period (cycle) of the sub-frames can be kept constant even when the number of frames and the number of sub-frames are changed. For example, if the unit period of the sub-frames is changed along with the changes of the number of frames and the number of sub-frames, the writing time (selection time) of a voltage or a current into each pixel is to be changed. This results in that control in the subfield driving becomes complex. Accordingly, when the unit period (cycle) of the sub-frames is kept constant, control in the subfield driving can be simplified in comparison with the above case.

It is to be noted that the image display device according to the aspect of the invention includes the image display device which displays an image by using the following electrooptic elements in addition to a liquid crystal display device which displays an image by using a liquid crystal element. For example, the electrooptic elements include an inorganic EL element, an organic EL element, a field electron emission element, a surface-conduction electron emission element, a ballistic electron emission element, an LED element, an electrophoresis element, an electrochromic element. In addition, in these electrooptic elements including the liquid crystal element, a distinction between a self-light-emitting electrooptic element and a non-light-emitting electrooptic element which changes a transmission rate or a reflection rate of outside light and a distinction between a current-driven electrooptic element driven by supplying a current and a voltage-driven electrooptic element driven by applying an electric field (voltage) are not required in operation. Further, the image display device according to the aspect of the invention includes a projection-type image display device which projects display light onto a display surface (for example, a screen) in addition to an image display device which emits display light directly reaching a viewer.

Further, an electronic apparatus according to another aspect of the invention includes the image display device as described above. The electronic apparatus includes a personal computer, a mobile phone, and the like, for example.

An image display method according to another aspect of the invention controls each gradation of a plurality of pixels in each of a plurality of sub-frames obtained by dividing one frame when a unit period to display one screen made of the plurality of pixels is set to be one frame. The image display method includes: detecting a magnitude of motion between frames from image data containing an image to be displayed; when the detected magnitude of the motion is large, adjusting the number of frames and the number of sub-frames such that the number of frames per unit time becomes larger and the number of sub-frames included in one frame becomes smaller in comparison with the case where the detected magnitude of the motion is small; and when the detected magnitude of the motion is small, adjusting the number of frames and the number of sub-frames such that the number of frames per unit time becomes smaller and the number of sub-frames included in one frame becomes larger in comparison with the case where the detected magnitude of the motion is large. With this configuration, the same effect as in the image display device according to the aspect of the invention can be achieved.

### BRIEF DESCRIPTION OF THE DRAWINGS

The invention will be described with reference to the accompanying drawings, wherein like numbers reference like elements.

FIG. 1 is a block diagram illustrating a configuration of a liquid crystal display device according to an aspect of an embodiment.

FIG. 2 is a diagram for explaining an operation (operation example 1) of a liquid crystal display device when a video signal of a still image is supplied.

FIG. 3 is a diagram for explaining frames and sub-frames in the operation example 1.

FIG. 4 is a diagram for explaining an operation (operation example 2) of a liquid crystal display device when a video signal of a moving image (of which motion between frames is not so large) is supplied.

FIG. 5 is a diagram for explaining frames and sub-frames in the operation example 2.

FIG. 6 is a diagram for explaining an operation (operation example 3) of a liquid crystal display device when a video signal of a moving image (of which motion between frames is significantly large) is supplied.

FIG. 7 is a diagram for explaining frames and sub-frames in the operation example 3.

FIG. 8 is a block diagram illustrating a configuration of a liquid crystal display device according to a modification 2.

FIG. 9 is a perspective view illustrating a specific example of an electronic apparatus according to an aspect of the invention.

FIG. 10 is a perspective view illustrating another specific example of an electronic apparatus according to an aspect of the invention.

FIG. 11 is a perspective view illustrating still another specific example of an electronic apparatus according to an aspect of the invention.

### DESCRIPTION OF EXEMPLARY EMBODIMENTS

### 1. Embodiment

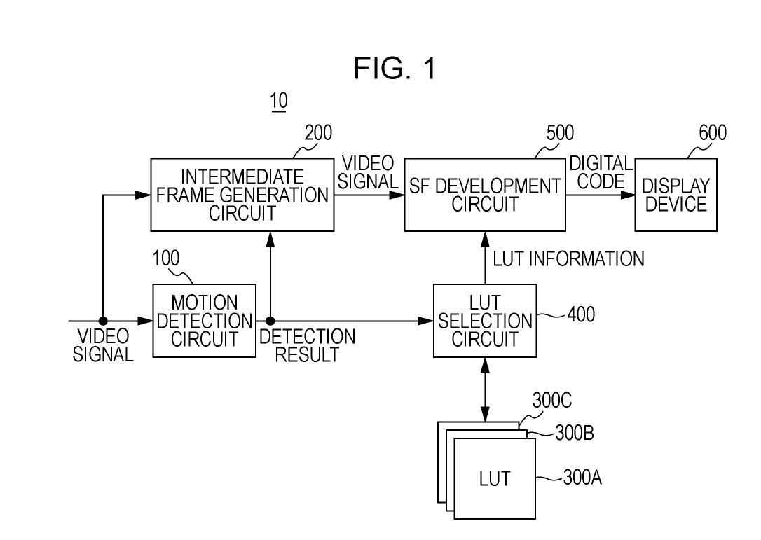

FIG. 1 is a block diagram illustrating a configuration of a liquid crystal display device 10 according to an aspect of an embodiment. As shown in FIG. 1, the liquid crystal display device 10 includes a motion detection circuit 100, an intermediate frame generation circuit 200, look-up tables (LUT) 300A to 300C, a LUT selection circuit 400, a sub-frame (SF) development circuit 500 and a display device 600. The display device 600 includes a plurality of scanning lines, a plurality of data lines and a plurality of pixels provided so as to correspond to each of intersections of the scanning lines and the data lines. Each pixel has a liquid crystal element including a pixel electrode, an opposite electrode, and a liquid crystal supported between the pixel electrode and the opposite electrode. Further, the display device 600 includes driving circuits (scanning line driving circuit and data line driving circuit) for driving each pixel. Each pixel is driven by the driving circuits of subfield driving.

In the subfield driving, one frame is divided into a plurality of sub-frames and a turn-on voltage or a turn-off voltage is written into each pixel of all pixels constituting one screen on a sub-frame basis. Therefore, a gradation of a display image is controlled by changing an effective value of the voltage applied to the liquid crystal. In other words, a turn-on voltage or a turn-off voltage is written into each pixel in each of 48 sub-frames, for example, and an intermediate gradation is expressed by time integration of the voltage applied. Voltage levels required for driving each pixel are only two values: an ON level and an OFF level. By using only ON and OFF digital signals to display an image, display unevenness caused by non-uniformity of element characteristics, interconnection resistance or the like can be suppressed. Thus, a gradation display at high definition can be realized. Note that one frame corresponds to a period required to display an image for one screen.

Further, the liquid crystal display device 10 according to the embodiment can change a frame frequency to either of 60 Hz, 120 Hz, or 240 Hz. That is to say, the number of frames per second can be changed to either of 60, 120, or 240. In addition, the liquid crystal display device 10 according to the embodiment can change the number of sub-frames per frame to either of 48, 24, or 12. As will be described in detail below, in the liquid crystal display device 10 according to the embodiment, when the frame frequency is set to 60 Hz, the subfield driving is performed while the number of sub-frames per frame is 48. When the frame frequency is set to 120 Hz, the subfield driving is performed while the number of sub-frames per frame is 24. When the frame frequency is set to 240 Hz, the subfield driving is performed while the number of sub-frames per frame is 12.

A video signal of a still image or a moving image is supplied to the motion detection circuit 100 and the intermediate frame generation circuit 200. In the embodiment, a frame frequency of the video signal supplied to the motion detection circuit 100 and the intermediate frame generation circuit 200 is 60 Hz. The motion detection circuit 100 compares an N^{th} (N=1, 2, 3 . . . ) frame image with a (N+1)^{th} frame image so as to detect a magnitude of motion between the frames, with respect to the supplied video signal. Based on the detected magnitude of the motion between the frames, the motion detection circuit 100 determines how many times a frame rate is to be multiplied by. Frame rate information indicating how many times the frame rate is to be multiplied by is output to the intermediate frame generation circuit 200 and the LUT selection circuit 400 as a detection result.

For example, when the supplied signal is a video signal of a still image, as the magnitude of motion between frames is zero, the motion detection circuit 100 outputs frame rate information, “1× speed”, as a detection result. When the supplied signal is a video signal of a moving image, the motion detection circuit 100 outputs frame rate information, “2× speed”, as a detection result if the magnitude of motion between frames is not so large, for example. In addition, the motion detection circuit 100 outputs frame rate information, “4× speed”, as a detection result if the magnitude of motion between frames is significantly large. It is to be noted that the motion detection circuit 100 may output numerical and/or level information indicating a magnitude of motion between frames, not the frame rate information, as a detection result.

When the detection result from the motion detection circuit 100 is “2× speed” or “4× speed”, the intermediate frame generation circuit 200 generates intermediate frame image(s) to change the frame rate of the video signal. For example, when the detection result from the motion detection circuit 100 is “2× speed”, the intermediate frame generation circuit 200 performs the following process with respect to the supplied video signal (frame frequency: 60 Hz). That is, the intermediate frame generation circuit 200 generates an intermediate frame image as an intermediate frame between an N^{th} frame and a (N+1)^{th} frame from an N^{th} frame image and a (N+1)^{th} frame image. Then, the intermediate frame generation circuit 200 interpolates the generated intermediate frame image, thereby converting the video signal having a frame frequency of 60 Hz to that having a frame frequency of 120 Hz. In this case, the intermediate frame generation circuit 200 changes the number of frames per second to 120 from 60.

In addition, when the detection result from the motion detection circuit 100 is “4× speed”, the intermediate frame generation circuit 200 performs the following process with respect to the supplied video signal (frame frequency: 60 Hz). That is, the intermediate frame generation circuit 200 generates three intermediate frame images between an N^{th} frame image and a (N+1)^{th} frame image. Thus, the intermediate frame generation circuit 200 converts the video signal having a frame frequency of 60 Hz to that having a frame frequency of 240 Hz. In this case, the intermediate frame generation circuit 200 changes the number of frames per second to 240 from 60.

When the detection result from the motion detection circuit 100 is “1× speed”, the intermediate frame generation circuit 200 generates no intermediate frame image. Then, the intermediate frame generation circuit 200 outputs the supplied video signal (frame frequency: 60 Hz) as it is to the SF development circuit 500.

Further, the liquid crystal display device 10 according to the embodiment has three look-up tables (LUT) 300A to 300C. The LUT 300A is a look-up table used when one frame is divided into 48 sub-frames to perform the subfield driving. The LUT 300B is a look-up table used when one frame is divided into 24 sub-frames to perform the subfield driving. The LUT 300C is a look-up table used when one frame is divided into 12 sub-frames to perform the subfield driving.

A digital code that specifies an ON state or an OFF state in each sub-frame is stored in each of these look-up tables for each gradation data. For example, a digital code as follows is stored in a look-up table for each of 8 gradation data when the number of sub-frames per frame is 12 and the number of gradations which can be expressed is 8. The digital code specifies an ON state (1) or an OFF state (0) in each sub-frame of first sub-frame to twelfth sub-frame. To be more specific, for example, if only the first sub-frame is in the ON state and the remaining second to twelfth sub-frames are in the OFF state for gradation data “001” among 8 gradation data, a digital code “100000000000” is stored in the look-up table so as to correspond to the gradation data “001”. Further, if the first to the fifth sub-frames are in the ON state and the remaining sixth to twelfth sub-frames are in the OFF state for gradation data “101”, a digital code “111110000000” is stored in the look-up table so as to correspond to the gradation data “101”.

The LUT selection circuit 400 selects any one of look-up tables from the LUT 300A to 300C based on a detection result from the motion detection circuit 100. The selected look-up table is output to the SF development circuit 500 as LUT information. The LUT selection circuit 400 selects a look-up table such that a result of multiplication of the number of frames per second by the number of sub-frames per frame is constant (2880).

For example, when the detection result from the motion detection circuit 100 is “1× speed”, the number of frames per second is set to 60. Therefore, the LUT selection circuit 400 selects the LUT 300A in which the number of sub-frames per frame is 48. When the detection result from the motion detection circuit 100 is “2× speed”, the number of frames per second is set to 120. Therefore, the LUT selection circuit 400 selects the LUT 300B in which the number of sub-frames per frame is 24. When the detection result from the motion detection circuit 100 is “4× speed”, the number of frames per second is set to 240. Therefore, the LUT selection circuit 400 selects the LUT 300C in which the number of sub-frames per frame is 12.

The SF development circuit 500 refers to a look-up table selected by the LUT selection circuit 400. Then, the SF development circuit 500 converts the video signal supplied from the intermediate frame generation circuit 200 to a digital code for the subfield driving so as to output the digital code to the display device 600. In addition, information specifying a frame frequency and information specifying the number of sub-frames per frame is transmitted to the display device 600 together with the digital code for the subfield driving. The display device 600 performs the subfield driving based on the digital code supplied from the SF development circuit 500 to display a video image of a still image or a moving image on a screen.

Next, operations of the liquid crystal display device 10 will be described.

### Operation Example 1

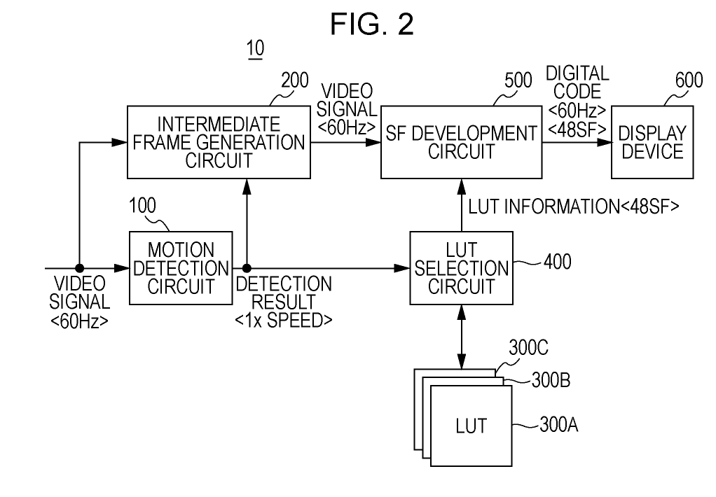

At first, an operation when a video signal of a still image is supplied will be described. In the case of a still image, a magnitude of the motion between frames is zero. Accordingly, as shown in FIG. 2, the motion detection circuit 100 outputs frame rate information, “1× speed”, as a detection result. Since the detection result from the motion detection circuit 100 is “1× speed”, the intermediate frame generation circuit 200 generates no intermediate frame image. Then, the intermediate frame generation circuit 200 outputs the supplied video signal (frame frequency: 60 Hz) as it is to the SF development circuit 500. In other words, the intermediate frame generation circuit 200 keeps the number of frames per second to 60.

Since the detection result from the motion detection circuit 100 is “1× speed”, the LUT selection circuit 400 selects the LUT 300A in which the number of sub-frames per frame is 48. The SF development circuit 500 refers to the LUT 300A and converts the video signal (frame frequency: 60 Hz) supplied from the intermediate frame generation circuit 200 to a digital code (frame frequency: 60 Hz, the number of sub-frames divided: 48) for the subfield driving so as to output the digital code to the display device 600. As a result, the display device 600 sets a frame frequency to 60 Hz and equally divides one frame into 48 sub-frames in performing the subfield driving. Thus, the display device 600 displays a video image of a still image on a screen.

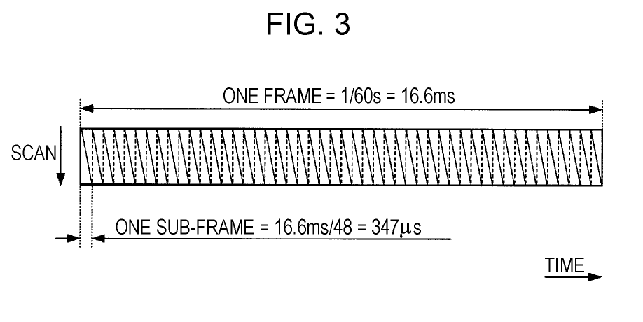

In this case, the number of sub-frames per frame can be increased in comparison with the operation examples 2 and 3 which will be described below. This makes it possible to realize a gradation display of a still image at high definition. As shown in FIG. 3, in the operation example 1, since the frame frequency is 60 Hz, a time length of one frame is 16.6 ms. In addition, since one frame is equally divided into 48 sub-frames, a time length of one sub-frame is 347 μs.

### Operation Example 2

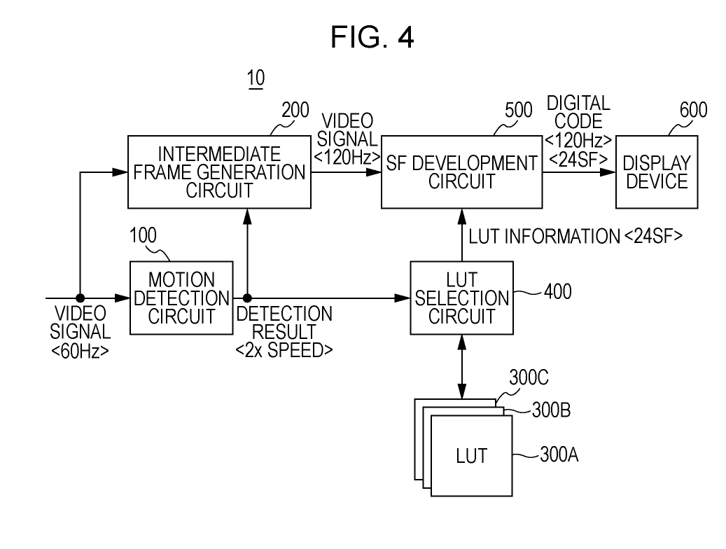

Next, an operation when a video signal of a moving image (of which motion between frames is not so large) is supplied will be described. As shown in FIG. 4, when the motion between frames is not so large, the motion detection circuit 100 outputs frame rate information, “2× speed”, as a detection result. Since the detection result from the motion detection circuit 100 is “2× speed”, the intermediate frame generation circuit 200 performs the following process with respect to the supplied video signal (frame frequency: 60 Hz). That is, the intermediate frame generation circuit 200 generates one intermediate frame image between an N^{th} frame image and a (N+1)^{th} frame image. Then, the intermediate frame generation circuit 200 converts the video signal having a frame frequency of 60 Hz to that having a frame frequency of 120 Hz. In this case, the intermediate frame generation circuit 200 changes the number of frames per second to 120 from 60.

Since the detection result from the motion detection circuit 100 is “2× speed”, the LUT selection circuit 400 selects the LUT 300B in which the number of sub-frames per frame is 24. The SF development circuit 500 refers to the LUT 300B and converts the video signal (frame frequency: 120 Hz) supplied from the intermediate frame generation circuit 200 to a digital code (frame frequency: 120 Hz, the number of sub-frames divided: 24) for the subfield driving so as to output the digital code to the display device 600. As a result, the display device 600 sets a frame frequency to 120 Hz and equally divides one frame into 24 sub-frames for the subfield driving. Thus, the display device 600 displays a video image of a moving image on a screen.

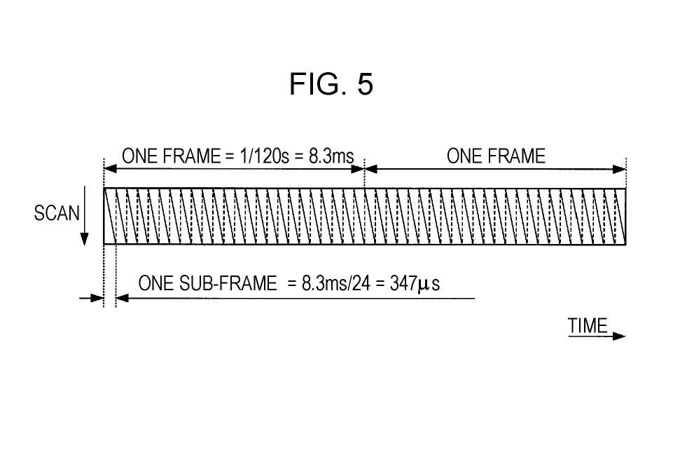

In this case, the number of sub-frames per frame is halved in comparison with the operation example 1. However, the number of frames per second can be doubled. This makes it possible to smoothly display a moving image by interpolating an intermediate frame image. As shown in FIG. 5, in the operation example 2, since a frame frequency is 120 Hz, a time length of one frame is 8.3 ms. However, since the number of sub-frames per frame is 24, a time length of one sub-frame is still 347 μs.

It is to be noted that even in the case of a video signal of a moving image, when the motion between frames is significantly small, a frame frequency is not changed to keep 60 Hz as in the case of a still image described in the operation example 1. Then, one frame can be equally divided into 48 sub-frames in performing the subfield driving.

### Operation Example 3

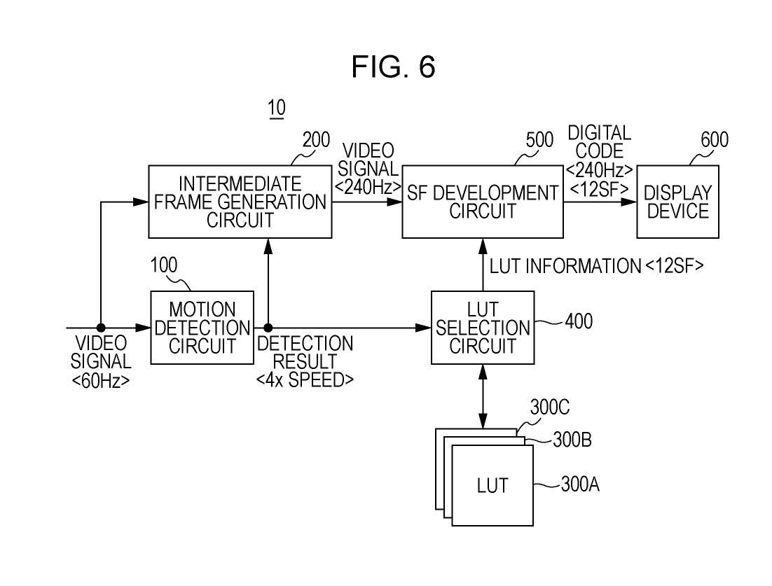

Next, an operation when a video signal of a moving image (of which motion between frames is significantly large) is supplied will be described. As shown in FIG. 6, when the motion between frames is significantly large, the motion detection circuit 100 outputs frame rate information “4× speed”, as a detection result. Since the detection result from the motion detection circuit 100 is “4× speed”, the intermediate frame generation circuit 200 performs the following process with respect to the supplied video signal (frame frequency: 60 Hz). That is, the intermediate frame generation circuit 200 generates three intermediate frame images between an N^{th} frame image and a (N+1)^{th} frame image. Then, the intermediate frame generation circuit 200 converts the video signal having a frame frequency of 60 Hz to that having a frame frequency of 240 Hz. In this case, the intermediate frame generation circuit 200 changes the number of frames per second to 240 from 60.

Since the detection result from the motion detection circuit 100 is “4× speed”, the LUT selection circuit 400 selects the LUT 300C in which the number of sub-frames per frame is 12. The SF development circuit 500 refers to the LUT 300C and converts the video signal (frame frequency: 240 Hz) supplied from the intermediate frame generation circuit 200 to a digital code (frame frequency: 240 Hz, the number of sub-frames divided: 12) for the subfield driving so as to output the digital code to the display device 600. As a result, the display device 600 sets a frame frequency to 240 Hz and equally divides one frame into 12 sub-frames for the subfield driving. Then, the display device 600 displays a video image of a moving image on a screen.

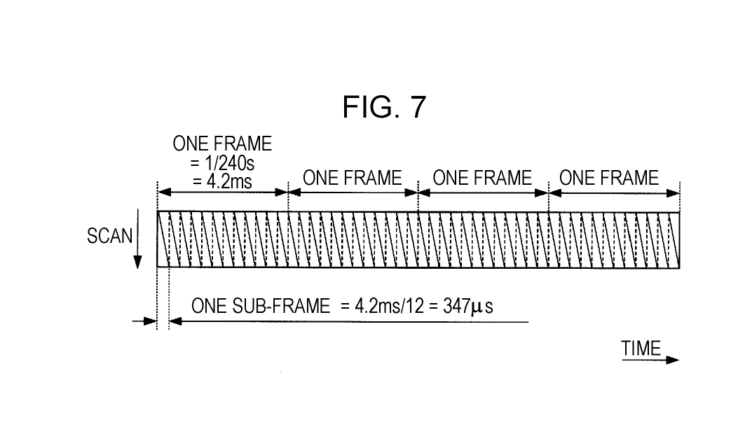

In this case, the number of frames per second is further doubled in comparison with the case in the operation example 2. This makes it possible to much smoothly display the moving image due to increase in the number of the interpolated intermediate frame images instead. As shown in FIG. 7, in the operation example 3, since a frame frequency is 240 Hz, a time length of one frame is 4.2 ms. However, since the number of sub-frames per frame is 12, a time length of one sub-frame is still 347 μs.

As described above, in the liquid crystal display device 10 according to the embodiment, when an image is displayed by the subfield driving, a magnitude of the motion between frames is detected from a video signal of a still image or a moving image. When the motion between frames is large, the number of frames per second is increased while the number of sub-frames per frame is reduced, in comparison with the case where the motion between frames is small. On the other hand, when the motion between frames is small, the number of frames per second is reduced while the number of sub-frames per frame is increased in comparison with the case where the motion between frames is large. In other words, in the case of an image of which motion between frames is large (for example, a moving image), even though definition of a gradation display is degraded by reducing the number of sub-frames per frame, the number of frames per second is increased to interpolate intermediate frame image(s) instead so as to smoothly display the image. On the other hand, in the case of an image of which motion between frames is small (for example, a still image), a display image does not change so large. Therefore, the number of frames per second is reduced, and the number of sub-frames per frame is increased instead, thereby realizing a gradation display at higher definition. Accordingly, when an image is displayed by the subfield driving, image quality can be suitably improved, regardless of the image to be displayed being a moving image or a still image.

In the liquid crystal display device 10, the number of frames per second and the number of sub-frames per frame are adjusted such that a result of multiplication of the number of frames per second by the number of sub-frames per frame is constant (2880). Therefore, a time length of the sub-frames is set to be constant at 347 μs in any case. If the time length of the sub-frames changes along with the change of the number of frames or sub-frames, the writing time (selection time) of voltage into each pixel is changed. This results in that control in the subfield driving becomes complex. Accordingly, when the time length of the sub-frames is set to be constant at 347 μs, control in the subfield driving can be simplified in comparison with the above case.

2. Modification

The invention is not limited to the above embodiment, and the following modifications can be made, for example. Further, two or more modifications described below can be appropriately combined.

Modification 1

In the embodiment described above, the motion detection circuit 100 may not detect the magnitude of motion between frames, but detect presence or absence of motion between frames. When the motion between frames is detected, information indicating that the image is a moving image may be output as a detection result. In contrast, when no motion between frames is detected, information indicating that the image is a still image may be output as a detection result.

In this case, when the detection result from the motion detection circuit 100 indicates a “moving image”, the intermediate frame generation circuit 200 performs the following process with respect to the supplied video signal (frame frequency: 60 Hz). That is, the intermediate frame generation circuit 200 generates an intermediate frame image between an N^{th} frame image and a (N+1)^{th} frame image. Then, the intermediate frame generation circuit 200 converts the video signal having a frame frequency of 60 Hz to that having a frame frequency of 120 Hz. In contrast, when the detection result from the motion detection circuit 100 indicates a “still image”, the intermediate frame generation circuit 200 generates no intermediate frame image, and outputs the supplied video signal (frame frequency: 60 Hz) as it is to the SF development circuit 500. Further, when the detection result from the motion detection circuit 100 indicates a “moving image”, the number of frames per second is set to 120. Therefore, the LUT selection circuit 400 selects the LUT 300B in which the number of sub-frames per frame is 24. In contrast, when a detection result from the motion detection circuit 100 indicates a “still image”, the number of frames per second is set to 60. Therefore, the LUT selection circuit 400 selects the LUT 300A in which the number of sub-frames per frame is 48.

When a moving image is displayed by changing the configuration as described above, the number of frames per second is increased while the number of sub-frames per frame is reduced, in comparison with the case where a still image is displayed. On the other hand, when a still image is displayed, the number of frames per second is reduced while the number of sub-frames per frame is increased, in comparison with the case where a moving image is displayed.

Modification 2

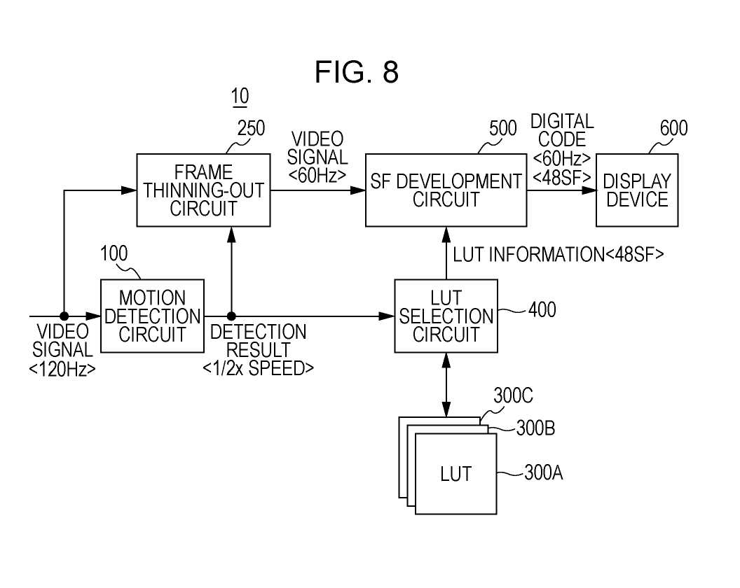

FIG. 8 is a block diagram illustrating a configuration of a liquid crystal display device 10 according to a modification 2. The liquid crystal display device 10 according to the modification is different from the liquid crystal display device 10 according to the above embodiment in the following points. That is, the liquid crystal display device 10 according to the modification includes a frame thinning-out circuit 250 instead of the intermediate frame generation circuit 200, as a frame number adjuster. Moreover, in the liquid crystal display device 10 according to the modification, a frame frequency of a video signal supplied to the motion detection circuit 100 and the frame thinning-out circuit 250 is not 60 Hz but 120 Hz.

For example, in the case where a video signal of a still image (frame frequency: 120 Hz) is supplied, when the motion detection circuit 100 detects that a magnitude of the motion between frames is zero, the motion detection circuit 100 outputs frame rate information, “½× speed”, as a detection result, in order to decrease the frame frequency to 60 Hz. Since the detection result from the motion detection circuit 100 is “½× speed”, the frame thinning-out circuit 250 performs the following process with respect to the supplied image signal (frame frequency: 120 Hz). That is, the frame thinning-out circuit 250 converts the video signal having a frame frequency of 120 Hz to that having a frame frequency of 60 Hz by deleting even-numbered frame images, for example. In this case, the frame thinning-out circuit 250 changes the number of frames per second to 60 from 120.

Since the detection result from the motion detection circuit 100 is “½× speed”, and the number of frames per second is set to 60, the LUT selection circuit 400 selects the LUT 300A in which the number of sub-frames per frame is 48. The SF development circuit 500 refers to the LUT 300A and converts the video signal (frame frequency: 60 Hz) supplied from the frame thinning-out circuit 250 to a digital code (frame frequency: 60 Hz, the number of sub-frames divided: 48) for the subfield driving so as to output the digital code to the display device 600. As a result, the display device 600 sets a frame frequency to 60 Hz and equally divides one frame into 48 sub-frames for the subfield driving. Then, the display device 600 displays a video image of the still image on a screen.

In this case, the number of frames per second is reduced and the number of sub-frames per frame is increased instead. This makes it possible to realize a gradation display of a still image at higher definition. Further, in the modification, since a frame frequency is 60 Hz, and the number of sub-frames per frame is 48, the number of frames per second and the number of sub-frames per frame are the same as those in the operation example 1 described above (see, FIG. 3). Namely, a time length of one frame is 16.6 ms, and a time length of one sub-frame is 347 μs.

When a frame frequency of the supplied video signal is 240 Hz and the detection result from the motion detection circuit 100 is “¼× speed”, for example, the frame thinning-out circuit 250 performs the following process with respect to the supplied video signal (frame frequency: 240 Hz). That is, the frame thinning-out circuit 250 leaves only a 4N^{th} frame image and deletes frame images other than the 4N^{th} frame image. Then, the frame thinning-out circuit 250 converts the video signal having a frame frequency of 240 Hz to that having a frame frequency of 60 Hz. Thus, the frame thinning-out circuit 250 decreases a frame rate of the video signal by thinning out the frame image data at a constant rate every predetermined number of continuous frames.

Modification 3

In the above embodiment, subfield driving in which either of the two data potential values, i.e., a turn-on voltage (light-on) or a turn-off voltage (light-off), is written into each pixel is described. However, subfield driving in which any one of three data potential values or more (turn-on voltage, turn-off voltage, intermediate voltage) is written may be employed. Further, the number of frames per unit time and the number of sub-frames per frame may be optionally changed without being limited to those described in the above embodiment.

3. Electronic Apparatus

Next, an electronic apparatus to which the liquid crystal display device 10 is applied will be described.

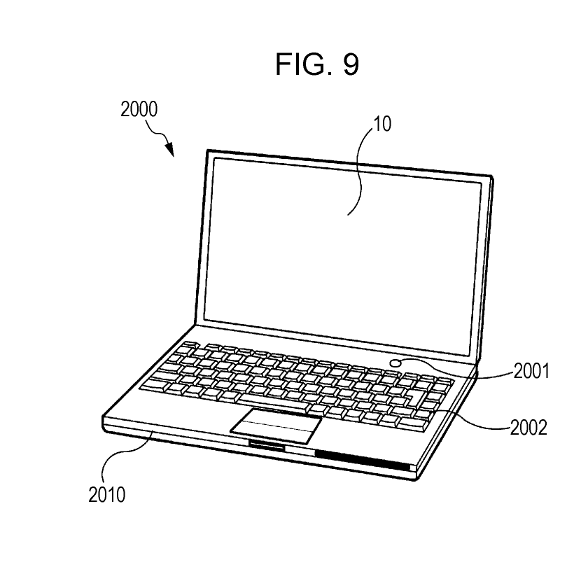

FIG. 9 illustrates a configuration of a mobile-type personal computer to which the liquid crystal display device 10 is applied. A personal computer 2000 includes the liquid crystal display device 10 as a display unit and a main body portion 2010. The main body portion 2010 is provided with a power switch 2001 and a keyboard 2002.

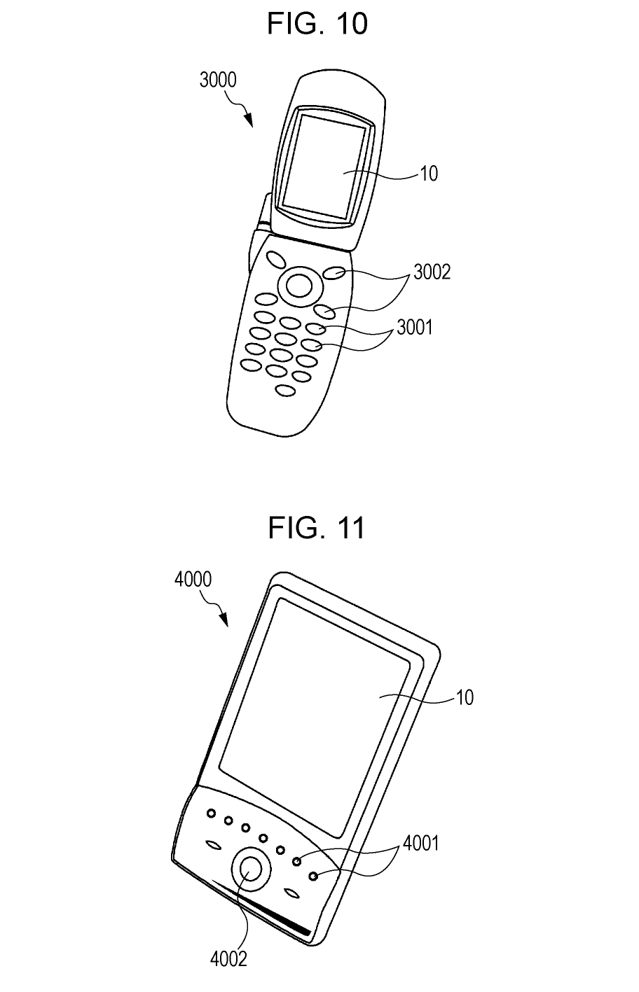

FIG. 10 illustrates a configuration of a mobile phone to which the liquid crystal display device 10 is applied. A mobile phone 3000 includes the liquid crystal display device 10 as a display unit, a plurality of operation buttons 3001 and scroll buttons 3002. The scroll buttons 3002 are operated for scrolling screen data displayed on the liquid crystal display device 10.

FIG. 11 illustrates a configuration of a personal digital assistants (PDA) to which the liquid crystal display device 10 is applied. A PDA 4000 includes the liquid crystal display device 10 as a display unit, a plurality of operation buttons 4001 and a power switch 4002. The operation buttons 4001 are operated to display various pieces of information such as an address list and a schedule book on the liquid crystal display device 10.

It is to be noted that as electronic apparatuses to which the liquid crystal display device 10 is applied, the following apparatuses can be exemplified in addition to those shown in FIG. 9 to FIG. 11. That is, a digital still camera, a television, a video camera, a car navigation system, a pager, an electronic organizer, an electronic paper, a calculator, a word processor, a workstation, a videophone, a POS terminal, a printer, a scanner, a copying machine, a video player, a projector and the like can be exemplified.

The entire disclosure of Japanese Patent Application No. 2009-043567, filed Feb. 26, 2009 is expressly incorporated by reference herein.

What is claimed is:

1. An image display device which controls each gradation of a plurality of pixels in each of a plurality of sub-frames obtained by dividing one frame when a unit period to display one screen made of the plurality of pixels is set to be one frame, comprising:
a motion detector that detects a magnitude of motion between frames from image data containing an image to be displayed;
a frame number adjuster that adjusts the number of frames per unit time based on a detection result from the motion detector;
a sub-frame number adjuster that adjusts the number of sub-frames included in one frame based on the detection result; and
a controller that controls the frame number adjuster and the sub-frame number adjuster such that: when the detected magnitude is large, the number of frames is made larger and the number of sub-frames is made smaller in comparison with the case where the detected magnitude is small; and when the detected magnitude is small, the number of frames is made smaller and the number of sub-frames is made larger in comparison with the case where the detected magnitude is large.

2. The image display device according to claim 1,
wherein the image data has frame image data corresponding to each frame, and
when the detected magnitude is large, the frame number adjuster generates intermediate image data corresponding to an intermediate frame between one frame and a frame next to the frame to increase the number of frames in comparison with the case where the detected magnitude is small.

3. The image display device according to claim 1,
wherein the image data has frame image data corresponding to each frame, and
when the detected magnitude is small, the frame number adjuster thins out the frame image data at a constant rate every predetermined number of continuous frames to reduce the number of frames in comparison with the case where the detected magnitude is large.

4. The image display device according to claim 1, further comprising;
a plurality of look-up tables indicating correspondence of a gradation to be displayed and an ON state or an OFF state in each of a plurality of sub-frames included in one frame in accordance with the number of sub-frames included in one frame,
wherein when the detected magnitude is large, the sub-frame number adjuster selects a look-up table from among the plurality of look-up tables in which the number of sub-frames is small so as to control each gradation of the plurality of pixels by using the selected look-up table, thereby reducing the number of sub-frames in comparison with the case where the detected magnitude is small, and
when the detected magnitude is small, the sub-frame number adjuster selects another look-up table from among the plurality of look-up tables in which the number of sub-frames is large so as to control each gradation of the plurality of pixels by using the selected look-up table, thereby increasing the number of sub-frames in comparison with the case where the detected magnitude is large.

5. The image display device according to claim 1,
wherein the motion detector detects presence or absence of motion between frames from the image data containing an image to be displayed,
when the detection result indicates presence of motion, the controller controls the frame number adjuster and the sub-frame number adjuster such that the number of frames is made larger and the number of sub-frames is made smaller in comparison with the case where the detection result indicates absence of motion, and
when the detection result indicates absence of motion, the controller controls the frame number adjuster and the sub-frame number adjuster such that the number of frames is made smaller and the number of sub-frames is made larger in comparison with the case where the detection result indicates presence of motion.

6. The image display device according to claim 1,
wherein the controller controls the frame number adjuster and the sub-frame number adjuster such that a result of multiplication of the number of frames by the number of sub-frames is constant.

7. The image display device according to claim 1,
wherein the sub-frame number adjuster adjusts the number of sub-frames such that a unit period of the sub-frames is constant even when the number of frames is changed.

8. An electronic apparatus including the image display device according to claim 1.

9. An image display method which controls each gradation of a plurality of pixels in each of a plurality of sub-frames obtained by dividing one frame when a unit period to display one screen made of the plurality of pixels is set to be one frame, comprising:
detecting a magnitude of motion between frames from image data containing an image to be displayed;
when the detected magnitude of the motion is large, adjusting the number of frames and the number of sub-frames such that the number of frames per unit time becomes larger and the number of sub-frames included in one frame becomes smaller in comparison with the case where the detected magnitude of the motion is small; and
when the detected magnitude of the motion is small, adjusting the number of frames and the number of sub-frames such that the number of frames per unit time becomes smaller and the number of sub-frames included in one frame becomes larger in comparison with the case where the detected magnitude of the motion is large.
